(19) United States
(12) Patent Application Publication
(10) Pub. No.: US 2026/0048952 A1
(43) Pub. Date: Feb. 19, 2026

(54) FOOD PRODUCT STACKER WITH MACHINE VISION INSPECTION AND METHODS FOR THE USE THEREOF

(71) Applicant: Pacproinc, LLC, Souderton, PA (US)

(72) Inventors: Carlos M. Ruiz, Gilbertsville, PA (US); Issac A. Moyer, Telford, PA (US); Nicholas J. Bohacz, Richboro, PA (US)

(73) Assignee: Pacproinc, LLC, Souderton, PA (US)

(21) Appl. No.: 19/291,981

(22) Filed: Aug. 6, 2025

Related U.S. Application Data
(60) Provisional application No. 63/683,489, filed on Aug. 15, 2024.

(51) Int. Cl. B65G 57/03

(52) U.S. Cl. CPC B65G 57/03; B65G 2201/0202

(57) ABSTRACT

A food product stacker includes a support moveable between a support position and a release position. A machine vision system includes an imaging device and a processor. The imaging device has a field of view encompassing the support platform and is configured to capture an image of the substrate supporting the food product on the support platform, to process the image and determine a position of the substrate on the support platform, and to provide an offset output signal corresponding to the position of the substrate on the support platform. A stacking conveyor is positioned support and is configured to receive the substrate and food product when the support is moved to the release position. The stacking conveyor is moveable in response to the offset output signal. Methods of stacking substrates supporting a food product are also provided.

### CROSS-REFERENCE TO RELATED APPLICATIONS

This application claims priority from U.S. Provisional Application No. 63/683,489, filed Aug. 15, 2024, which is hereby fully incorporated by reference herein in its entirety.

### FIELD OF THE INVENTION

The present application relates generally to a food product stacker, and in particular to a food product stacker with machine vision inspection, and to methods for the use and assembly thereof.

### BACKGROUND

Food processing systems may be configured with a food product stacker, which stacks a plurality of substrates, each supporting a food product respectively. It is important to the final packaging configuration to have alignment of the stacked substrates supporting the food products. Typically, manual inspection is conducted to ensure that the leading/trailing edges of the stacked substrates are properly aligned. Such inspection may require adequate space to accommodate an operator, and may lead to some inconsistencies in the stack quality. In addition, the operator may inspect the product for quality control, and reject certain products, for example if presented with partial food product pieces and/or an incorrect count of food product. Such multi-tasking may lead to inadvertent omissions in controlling the stacking alignment and food product quality.

### SUMMARY

The present invention is defined by the following claims, and nothing in this section should be considered to be a limitation on those claims.

In one aspect, one embodiment of a food product stacker for a food processing system includes at least one support moveable between a support position, wherein the support defines at least in part a support platform configured to receive and support a substrate supporting a food product, and a release position, wherein the support defines an opening. A machine vision system includes an imaging device and a processor. The imaging device has a field of view encompassing the support platform and is configured to capture an image of the substrate supporting the food product supported by the support platform. The processor is configured to process the image and determine a position of the substrate on the support platform. The processor is configured to provide an offset output signal corresponding to the position of the substrate on the support platform. A stacking conveyor is positioned under the opening and is configured to receive the substrate supporting the food product when the support is moved to the release position, wherein the stacking conveyor is moveable in response to the offset output signal.

In another aspect, one embodiment of a food processing system includes a food product stacker, as otherwise disclosed herein, and an interleaver positioned upstream of the stacker, wherein the interleaver deposits the food product onto the substrate. In other embodiments, the system may further include a reject conveyor and/or a diverter, together with additional food stacker(s).

In another aspect, one embodiment of a method of stacking substrates with food product includes moving a substrate supporting a food product onto a support defining a support platform, capturing an image of the substrate supporting the food product on the support platform with an imaging device, processing the image of the substrate supporting the food product with a processor, determining a position of the substrate supporting the food product on the support platform, generating an offset output signal corresponding to the position of the substrate on the support platform, moving a stacking conveyor in response to the offset output signal, moving the support so as to release the substrate supporting the food product, and depositing the substrate supporting the food product onto the stacking conveyor.

The various embodiments of the food product stacker, food processing system and methods provide significant advantages over other food product stackers, food processing systems, and methods for the assembly and use thereof. For example, and without limitation, the machine vision system provides an efficient and unique system for ensuring alignment of successively stacked substrates, and avoids the need for manual inspection. The machine vision system may further serve double duty by also inspecting the food product for pass/fail processing. The overall stacker, and food processing line, may be made more compact, with a substantial reduction in the footprint of the stacker and line, thereby improving the efficient use of space and reducing the overall required square footage for the system and the associated costs of the stacker and space. The stacker, and food processing system, are able to run without user input, with the stacker automatically maintaining proper alignment, and with rejected food product being automatically directed offline for further processing.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a side view representation of an exemplary food processing system.

FIG. 2 is partial, perspective view of one embodiment of a food product stacker assembly including a pair of food product stackers.

FIG. 3 is a partial, plan view of the food product stacker assembly shown in FIG. 2 including a rework conveyor system.

FIG. 4 is a partial, perspective view of one embodiment of a food product stacker.

FIGS. 5A-C are plan views of the food product stacker processing a substrate supporting a food product for subsequent stacking and/or rework.

FIG. 6A and B are side views of the food product stacker adjusting a stacking conveyor for reception of the substrate supporting a food product.

FIGS. 7A-C are perspective side views of the food product stacker processing a rejected substrate supporting a food product for rework.

FIG. 8A is a perspective view of a paddle assembly.

FIG. 8B is an exploded perspective view of the paddle assembly shown in FIG. 8A.

FIG. 9A is a perspective view of a stacking conveyor.

FIG. 9B is an exploded perspective view of the stacking conveyor shown in FIG. 9A.

FIG. 10 is a flow diagram showing the processing of a substrate supporting a food product.

FIG. 11 is a perspective view of a pair of paddles moveable between a support position and a release position.

FIG. 12A is a schematic end view of the paddles shown in FIG. 11 in the support position.

FIG. 12B is a schematic end view of the paddles shown in FIG. 11 in the release position.

### DETAILED DESCRIPTION OF THE PRESENTLY PREFERRED EMBODIMENTS

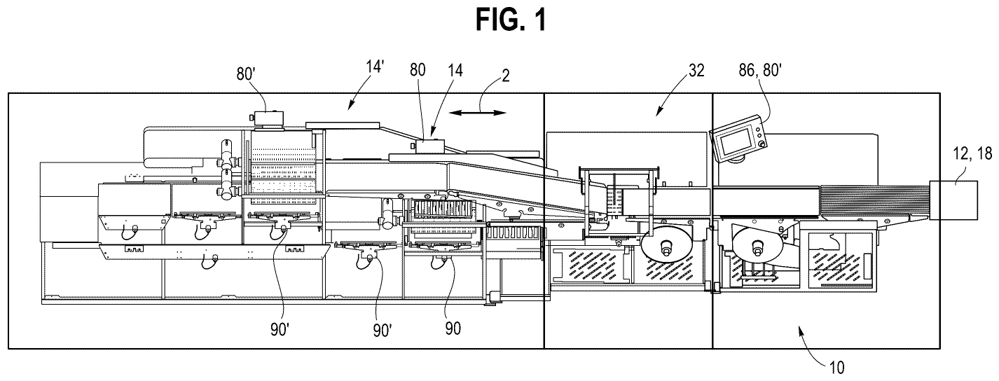

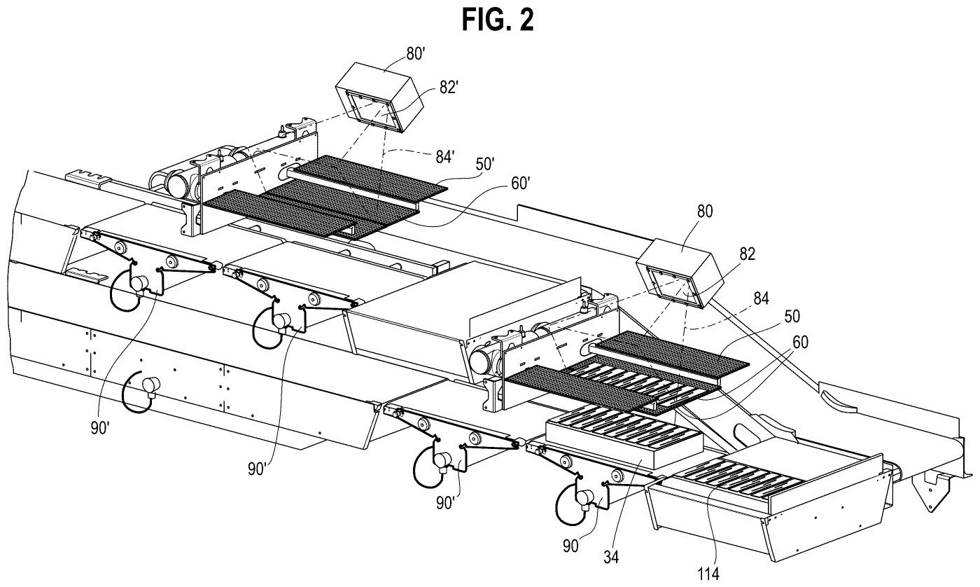

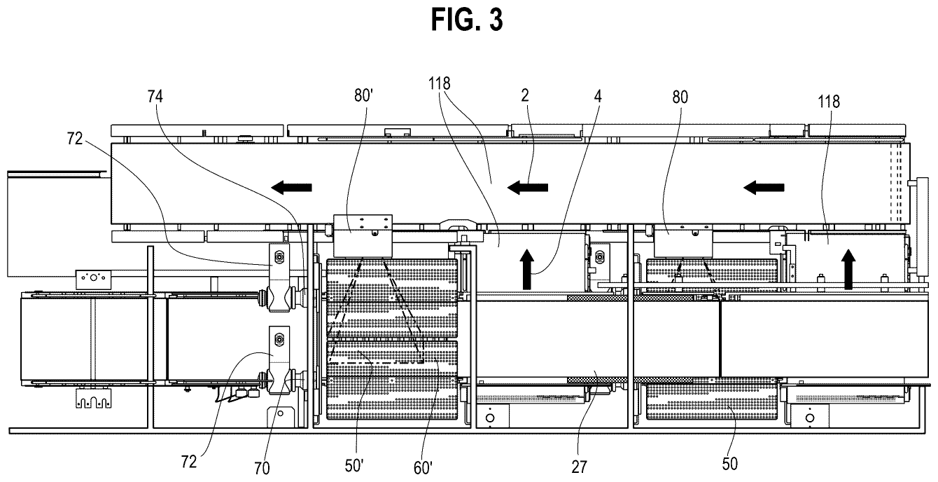

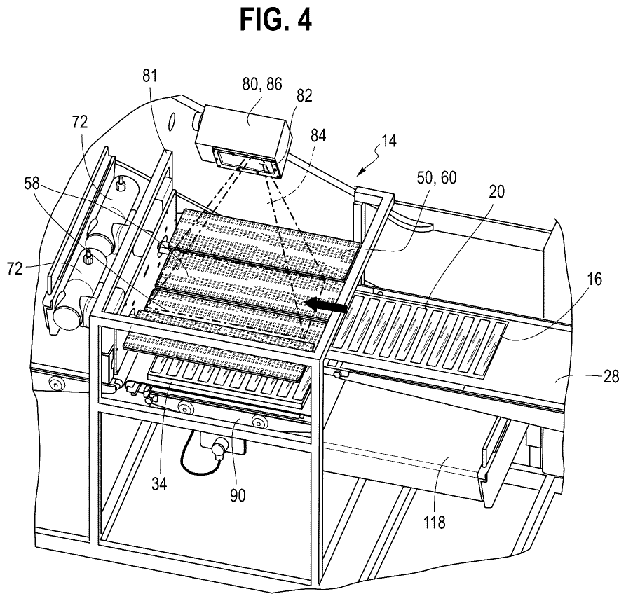

It should be understood that the term “plurality,” as used herein, means two or more. As shown in FIGS. 1-4, the term “longitudinal,” as used herein, means of or relating to a length or lengthwise direction 2, for example the flow direction of a food product in a food processing system. The term “lateral,” as used herein, means situated on, directed toward or running in a transverse or side-to-side direction 4, for example as shown in FIG. 3. The term “coupled” means connected to or engaged with whether directly or indirectly, for example with an intervening member, and does not require the engagement to be fixed or permanent, although it may be fixed or permanent. The terms “first,” “second,” and so on, as used herein, are not meant to be assigned to a particular component or feature so designated, but rather are simply referring to such components and features in the numerical order as addressed, meaning that a component or feature designated as “first” may later be a “second” such component or feature, depending on the order in which it is referred. It should also be understood that designation of “first” and “second” does not necessarily mean that the two components, features or values so designated are different, meaning for example a first direction may be the same as a second direction, with each simply being applicable to different components or features. The terms “upper,” “lower,” “rear,” “front,” “fore,” “aft,” “vertical,” “horizontal,” and variations or derivatives thereof, refer to the orientations of the exemplary food product stacker as shown in FIGS. 1 and 4.

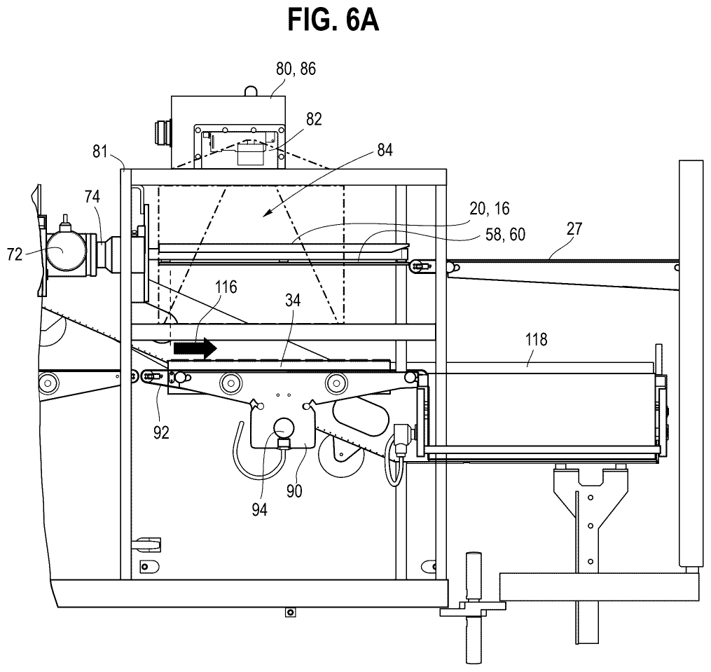

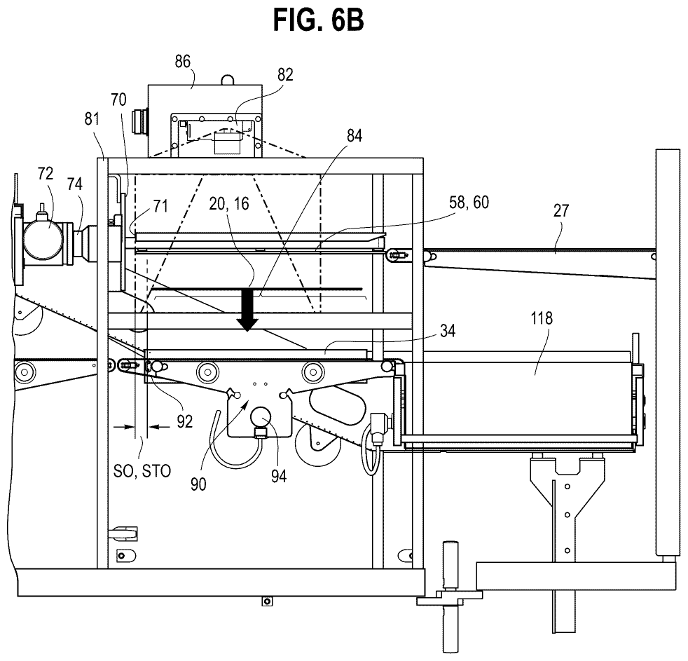

As shown in FIGS. 1, 2 and 4, a schematic illustration is provided for a food processing system 6, otherwise referred to as a food preparation line, that interleaves a substrate 20 (e.g., a substrate sheet) under food products 16 via an interleaver 10. In one embodiment, the substrate 20 is paper. One of ordinary skill in the art would understand that the substrate 20 may be formed from other materials. The food processing system may include a slicer/former 12. The slicer/former 12 may be equipment for slicing meats, including for limitation sliced bacon, and creating food setups, or may be a former of meat patties, such as for hamburgers, or other food items. A feed conveyor 18 may convey the food products 16, which will be commonly referred to as a “food preparation,” downstream from the slicer/former 12 to other packaging and handling equipment, shown for example as the interleaver 10. In this embodiment, the interleaver 10 may be located immediately downstream from the feed slicer/former 12. The interleaver 10 inserts the substrate 20 beneath the food preparation, or food product 16, as the food product 16 travels onto and past the interleaver 10. The interleaver 10 includes an interleaver conveyor 24, which receives the food product 16 and the substrate 20 nearly simultaneously, and then deposits the food product 16, which is now on a substrate 20, onto an infeed conveyor 28 of a food stacker 14, which conveyor may be incorporated in a diverter 30. The diverter 32 may be located between the interleaver 10 and stacker 14. The diverter 32 may divert a portion of the stream of substrates 20 supporting a food product, for example in an alternating sequence, to multiple stackers 14, 14′, for example diverting every other substrate 20 with a food product 16 to a second food stacker 14′. The stacker(s) 14, 14′ stack the substrates 20 with interleaved food products 16 one on top of the other to form a stack 34 of substrates with food product, as shown for example in FIG. 6B. The stack 34 includes a plurality of substrates supporting food products, and may include in some embodiments between 5 and 30 substrates. The stack 34 of the substrate interleaved food preparations may then be transported by a conveyor and deposited onto a tray (not shown), which is carried further downstream for further packaging and/or handling. Those skilled in the art will understand that various types of slicers/formers 12, interleavers 10 and/or tray feeders may be utilized in various food preparation lines in which the food product stacker(s) 14, 14′, in accordance with the present invention, may be used.

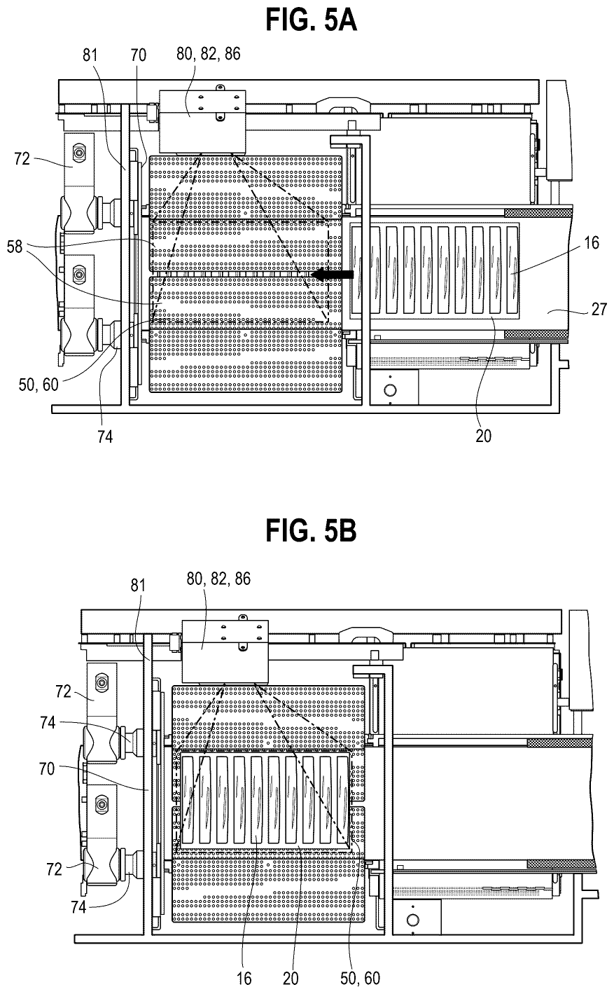

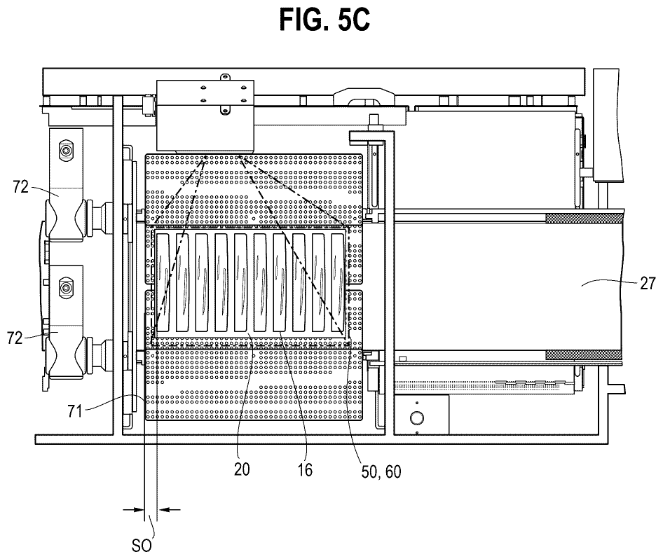

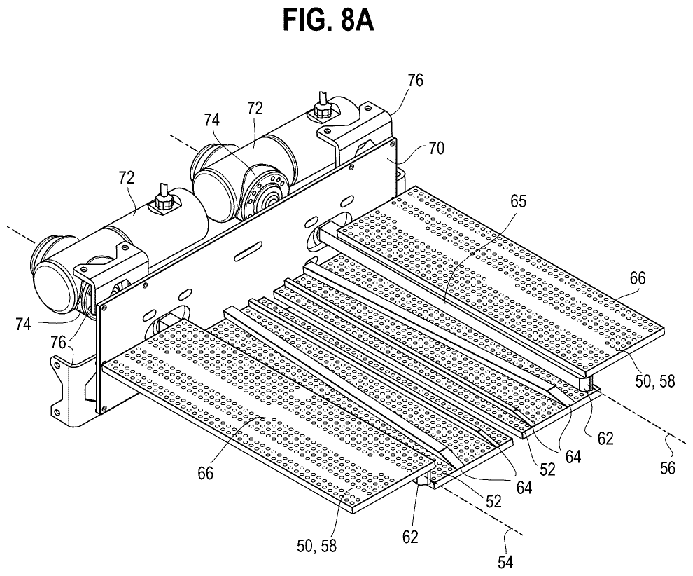

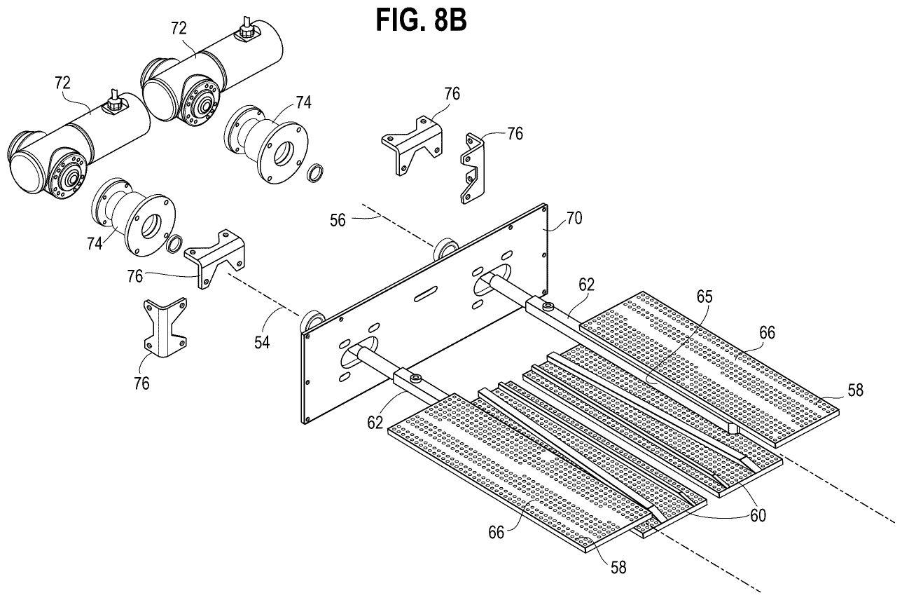

Referring to FIGS. 1-9B and 11-12B, the food product stacker 14, 14′ includes at least one support 50 moveable between a support position, wherein the support defines at least in part a support platform 52 configured to receive and support the substrate 20 supporting the food product 16, and a release position, wherein the support 50 defines an opening. In one embodiment, shown in FIG. 8A and B and 12A and B, the at least one support includes a pair of supports 50, shown as a pair of stacker paddles 58, which are rotatably mounted about laterally spaced rotation axes 54, 56 extending in the longitudinal direction 2. Each paddle 58 includes a lower (inner) support platform 60 extending laterally from the axis 54, 56 when the paddle is in the support position, and/or radially inwardly from the axes 54, 56, when the paddle is in the support position. The paddle 58 further includes a central support 62, or axle, that rotates about the axis 54, 56 and defines a side wall 65 along which the substrate and food product may be guided, and which may reduce any lateral variance during the stacking operation. Each support may include one or more rails 64, or guides, each configured with a ramp at a leading edge thereof, for supporting the substrate 20. The rails 64 assist with the transfer of the substrate with product onto the paddles 58 and reduce the surface area contact between the paddles 58 and the substrate 20 for an easier release.

The paddles 58 each include an upper (outer) platform 66 extending radially/laterally outwardly from the central support 62 when the paddle 58 is in the support position. The upper platform 66 is vertically offset from the lower platform 60 when the paddles are in the support position. In one embodiment, the paddles 58 rotate 90 degrees from the support position to the release position, wherein the paddles 58 are in a vertical orientation, and thereby release the product through the opening between the paddles 58. The paddles 58 rotate another 90 degrees to a support position, wherein the upper platform 66, now rotated 180 degrees, presents as the lower platform 60, and vice versa, including rails that now face upwardly. In other embodiments the paddles 58 may simply rotated reciprocally such that the lower/inner platforms always receive the substrate. In other embodiments, the paddles may translate toward and away from each other to support and release the substrate and product.

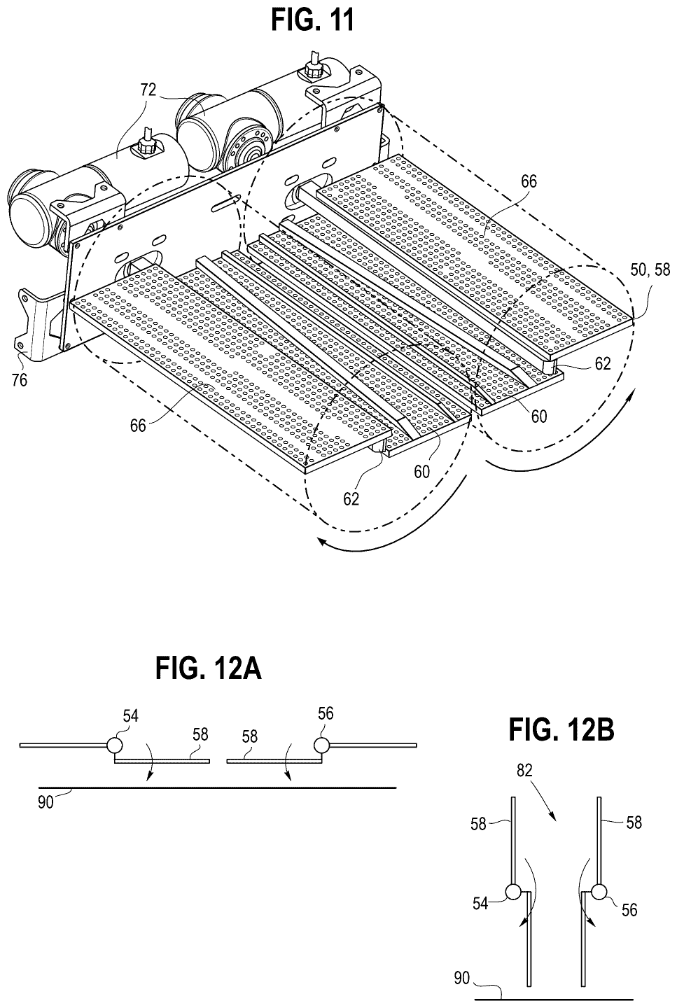

The paddles 58 are each cantilevered outwardly from a rear support plate 70. A pair of servo motors 72 are coupled to the paddles 58, and the axle 62 in particular. The motors 72 are respectively mounted to the rear surface of the plate 70 with a pair of mounting supports 74, and actuate the paddles 58 in a reciprocal rotation between the support position and the release position. The plate 70 may be secured to a frame 81 with one or more support brackets 76. As shown in FIG. 12B, the opening 82 is defined between the support platforms 60, having a vertical orientation, when position in the release position. In this embodiment, the stacker paddles 58 have a horizontal orientation in the support position (FIG. 12A) and a vertical orientation in the release position (FIG. 12B).

The infeed conveyor 27 is positioned upstream of the at least one support 50, wherein the infeed conveyor is configured to feed the substrate supporting the food product to the at least one support, for example onto the support platforms 60 when the paddles are in the support position, shown in FIG. 12A.

Referring to FIGS. 1 and 4-7C, the food stacker further includes a machine vision system 80. The machine vision system includes an imaging device 82 having a field of view 84 encompassing the support platforms 60, both lengthwise in the longitudinal direction and widthwise in the lateral direction. In one embodiment, the imaging device 82 includes a camera. The imaging device 82 is configured to capture an image of the substrate 20 supporting the food product 16 when positioned on and supported by the support platforms 60. The imaging device may use 2d visible light imaging, or other types of imaging including without limitation multispectral imaging, hyperspectral imaging, infrared light, line scan imaging, 3D imaging and other suitable imaging systems.

The machine vision system also includes a processor 86 configured to process the image and determine a position of the substrate 20 on the support platforms 60. The processor 86 is configured to provide an offset output signal 88 corresponding to the position of the substrate 20 on the support platforms 60. The imaging device 82 may be separate from the processor 86, or integrated therewith as an image processing unit, for example as a smart camera. The full processing function may be included in the same housing or enclosure as the camera so as to provide embedded processing. In one embodiment, the processor 86 may be located in a main control panel 130, which has a user interface for controlling the food processing system.

The processor may include a CPU, GUP, FPGA or combinations thereof, and capable of running a computer program. A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware, as well as other electronic components. The term “circuitry” would also cover, for example and if applicable to the particular claim element, a baseband integrated circuit or applications processor integrated circuit for a mobile computing device or a similar integrated circuit in server, a cellular network device, or other network device.

Processors suitable for the execution of a computer program include, by way of example, both general and special purpose microprocessors, and any one or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, or one or more of the control modules, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Referring to FIGS. 4-7C, 9A-10 and 12A and B, a stacking conveyor 90 is positioned under the paddles 58 and opening 82 and is configured to receive the substrate 20 supporting the food product 16 when the support 50, or paddles 58, are moved to the release position. The substrate 20 supporting the food product 16 drops, under the force of gravity, through the opening 82 and onto the stacking conveyor 90, or onto previously deposited substrates supporting the food product and defining the stack 34.

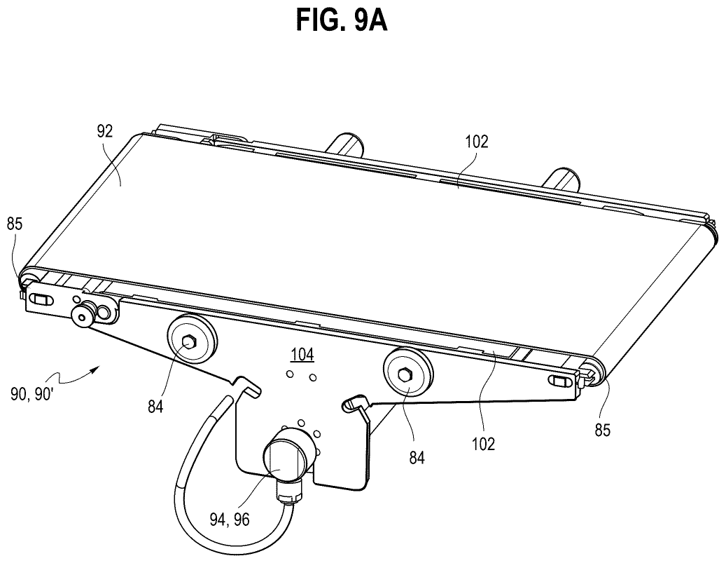

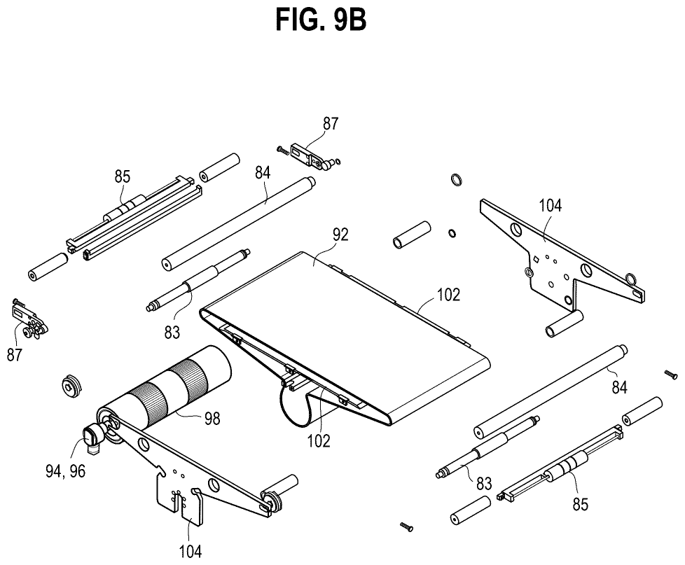

The stacking conveyor 90 includes a belt 92, which wraps around a series of laterally extending rollers 83, 84, 85, and is reciprocally moveable in the longitudinal direction in response to the offset output signal 88 received from the processor. Tensioning devices 87 may be manipulated to increase the tension of the belt 92 on the rollers. In operation, the processor 86 processes the image of the substrate 20 and food product 16 and determines a position of the substrate 20 on the support platforms 60. The processor 86 is configured to provide the offset output signal 88 corresponding to the position of the substrate 20 on the support platforms 60. In one embodiment, a standard offset STO, for example an offset of the substrate relative to a rear/downstream edge 71 of the support platforms 60, or calibrated origin, is determined. For example, the standard offset (STO) may be 0.50 inches. As the substrate 20 supporting the food product 16 is introduced to the support platforms 60, the imaging device 82 captures an image 100 of the substrate 20 relative to the edge 71 of the support platforms 60, or other defining feature of origin, and determines a substrate offset thereof. It should be understood that the offset may be measured relative to other components or features, including for example a front surface of the support plate 70. The substrate offset (SO) is compared with the standard offset (STO) to determine a variance or difference therebetween. The processor provides the offset output signal 88 to the stacking conveyor 90, and moves the conveyor 90, and in particular the belt 92, such that the substrate 20 on the platforms 60 is aligned with a target region of the stacking conveyor 90, or is aligned with already deposited substrate(s) supported thereby and defining a stack 34. In some embodiments, the variance may be 0, such that the stacking conveyor 90 is not moved in either longitudinal direction 2. In other embodiments, the variance may be (−) or (+), with the output signal 88 moving the staking conveyor upstream (left) or downstream (right) in response thereto, such that each successive substrate 20 is stacked and aligned with the stack 34 of substrates 20 positioned on the conveyor 90. For example, as shown in FIG. 6A, the conveyor moves the stack 34 to the right, or direction 116, in response to the output signal 88 so as to align the stack 34 with the substrate 20 carried or supported the support 50, or platform 60. The stacking conveyor 90 may include an encoder 96 on a servo drive motor 94, which is engaged with and drives the belt 92 such that the position of the stacking conveyor is known, and may be adjusted in response to the output signal 88. The belt 92 may be a flat or toothed belt so as to accurately advance or retract the conveyor in response to the output signal. As shown in FIGS. 9A and 9B, the belt 92 loops around a drive cylinder 98 coupled to the servo drive motor 94. A pair of laterally spaced plates 104 support and capture the rollers 84 and cylinder 98. A pair of laterally spaced guides 102 are coupled to the plates

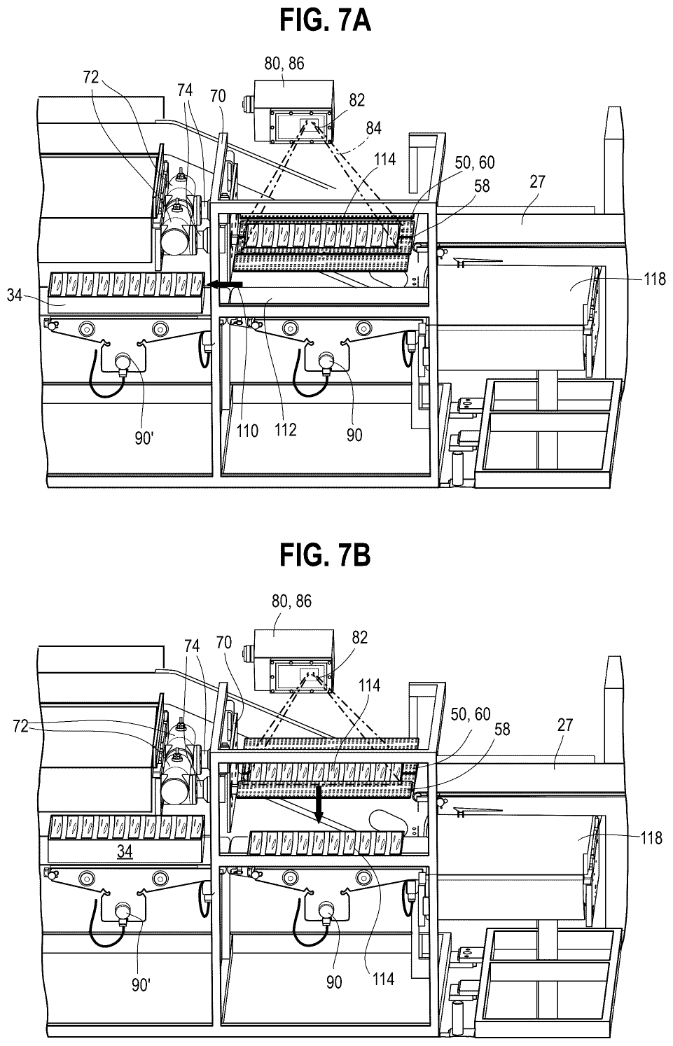

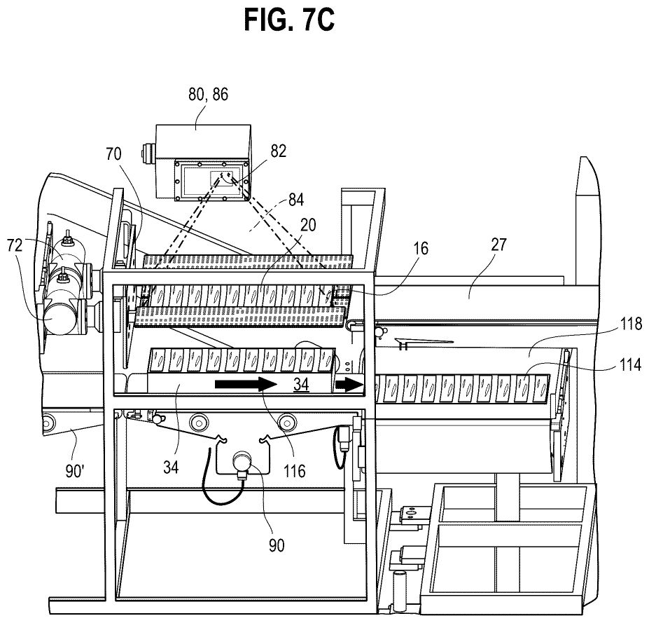

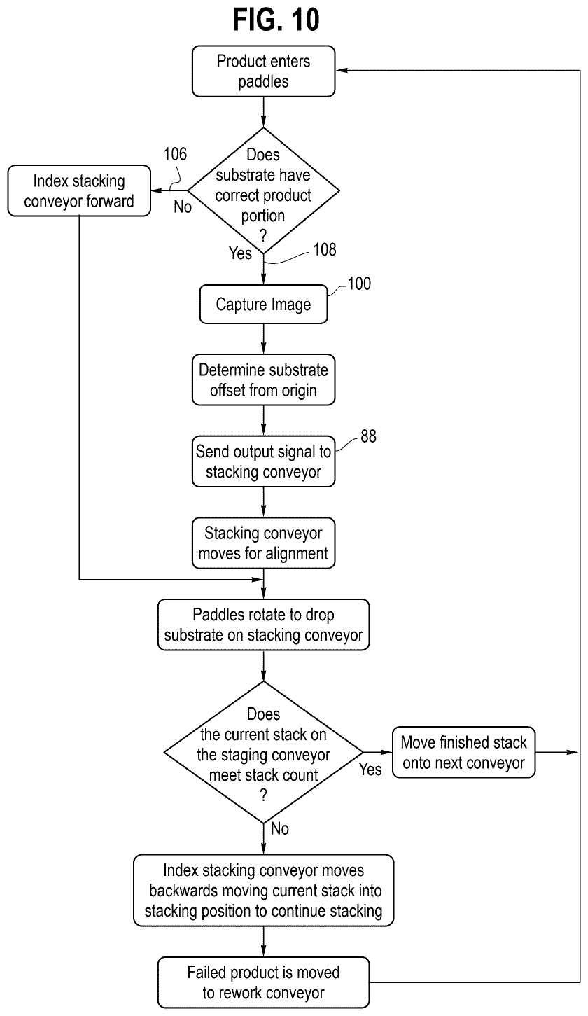

The processor 86 also is configured to process the image 100 from the imaging device 82 to determine whether the substrate 20 and/or the food product 16 in the field of view 84, as supported by the platforms 60, satisfies one or more pass/fail criteria and to provide correspondingly a pass output signal 108 or a fail output signal 106, as shown in FIG. 10. For example, if the substrate is ripped, torn, or otherwise deficient, or if the food product is missing, partially or completely, or does not have the proper number of pieces, the process may send a fail output signal 106. The stacking conveyor 90, if supporting one or more previously deposited substrates with a food product, or stack 34, is moveable in a first direction 110, shown in FIG. 7A, in response to the fail output signal 106 so as to provide an exposed surface 112 for receiving a failed substrate and food product 114. A similar stacking conveyor 90′ may be positioned upstream of the stacking conveyor 90 to receive the stack while the failed substrate and product 114 are removed from the sequence, and to move the stack 34 back to the first stacking conveyor once the failed substrate and product 114 has been removed. The stacking conveyors 90, 90′ operate in sequence, and may be controlled by the same controller. The stacking conveyor 90, 90′ is then moveable in a second direction 116 opposite the first direction 110, as shown in FIG. 7C, so as to reposition the one or more previously deposited substrates with the food product, or stack 34, under the at least one support so as to be positioned to receive additional substrates 20 supporting a food product 16. The movement in the second direction 116 moves the failed substrate and food product 114 to a rework or reject conveyor 118, whereinafter the failed substrate and food product 114 may be transported to a station for removing the food product 16 from the substrate 20 and reintroducing the food product, if meeting certain pass standards, into the production cycle. The reject conveyor 118 is positioned to receive the failed substrate and food product 11 from the stacking conveyor 90 as the stacking conveyor is moved in the second direction 116.

As shown in FIGS. 1, 2 and 3, the stacker may include a first stacker 14 and a second stacker 14′, both operating as disclosed herein. The diverter 32 is positioned between the interleaver 10 and the first and second stackers 14, 14′. The diverter 32 is configured to feed the substrates 20 supporting the food product 16 alternatively to the first stacker 14 and to the second stacker 14′, or may feed the diverted substrates in some other alternating sequence. The second stacker 14′ may also include at least one second support 50′ moveable between a second support position and a second release position, a second machine vision system 80′ comprising a second imaging device 82′ having a second field of view 84′ encompassing the second support platform 60′ and configured to capture an image of the substrate 20 supporting the food product 16 supported by the second support platform 60′, and a second processor 86′ configured to process the image and determine a position of the substrate on the second support platform 60′. The second processor 86′ is configured to provide a second offset output signal corresponding to the position of the substrate on the second support platform. The first and second processors 86, 86′ may be integrated as a single processor. A second stacking conveyor 90′ is positioned under the second support 60′ and is configured to receive the substrate supporting the food product passing through the opening when the second support 50′ is moved to the release position, wherein the second stacking conveyor 90′ is moveable in response to the second offset output signal.

In operation, one method of stacking substrates 20 with food product 16 includes moving the substrate 20 supporting the food product 16 onto the support 50 defining the support platform 60, capturing the image 100 of the substrate supporting the food product on the support platform with an imaging device 82, processing the image of the substrate supporting the food product with a processor 86, determining a position of the substrate 20 supporting the food product on the support platform 60, generating the offset output signal 88 corresponding to the position of the substrate on the support platform, moving a stacking conveyor 90 in response to the offset output signal, moving the support 50 so as to release the substrate 20 supporting the food product, and depositing the substrate 20 supporting the food product onto the stacking conveyor 90, for example onto the stack 34 supported by the conveyor.

The operation of moving the substrate 20 supporting the food product onto the support 50 may include moving the substrate supporting the food product onto the pair of stacker paddles 58 rotatably mounted about laterally spaced rotation axes 54, 56, and the operation of moving the support 50 so as to release the substrate supporting the food product includes rotating the pair of stacker paddles 58 about the rotation axes between the support position and the release position, wherein the support paddles 58 define the opening 82 therebetween when rotated to the release position. The operation of moving the substrate 20 supporting the food product onto the support 50 comprises feeding the substrate supporting the food product to the support from the infeed conveyor 27 positioned upstream of the support. The operation of the system may also include determining whether the substrate 20 and/or the food product 16 on the support platform satisfies one or more pass/fail criteria and generating the pass output 108 signal 108 or the fail output signal 106. If supporting one or more previously deposited substrates with a food product (e.g., single or stack 34), the stacking conveyor 90 may be moved in the first direction 110 in response to the fail output signal so as to provide an exposed surface for receiving a failed substrate and food product 114, releasing the failed substrate and food product onto the exposed surface, and moving the stacking conveyor in the second direction 116 opposite the first direction so as to reposition the one or more previously deposited substrates with the food product, e.g., stack 34, under the support 50 for subsequent stacking operations.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A food product stacker for a food processing system comprising:
at least one support moveable between a support position, wherein the support defines at least in part a support platform configured to receive and support a substrate supporting a food product, and a release position, wherein the support defines an opening;
a machine vision system comprising:
an imaging device having a field of view encompassing the support platform and configured to capture an image of the substrate supporting the food product supported by the support platform; and
a processor configured to process the image and determine a position of the substrate on the support platform, wherein the processor is configured to provide an offset output signal corresponding to the position of the substrate on the support platform; and
a stacking conveyor positioned under the opening and configured to receive the substrate supporting the food product when the support is moved to the release position, wherein the stacking conveyor is moveable in response to the offset output signal.

2. The food product stacker of claim 1 wherein the at least one support comprises a pair of stacker paddles rotatably mounted about laterally spaced rotation axes, wherein the stacker paddles are rotatable about the rotation axes between the support position and the release position, wherein the support paddles define the opening therebetween when moved to the release position.

3. The food product stacker of claim 2 wherein the stacker paddles have a horizontal orientation in the support position and a vertical orientation in the release position.

4. The food product stacker of claim 1 further comprising an infeed conveyor positioned upstream of the at least one support, wherein the infeed conveyor is configured to feed the substrate supporting the food product to the at least one support.

5. The food product stacker of claim 1 wherein the processor is further configured to process the image and determine whether the substrate and/or the food product in the field of view satisfies one or more pass/fail criteria and to provide correspondingly a pass output signal or a fail output signal, wherein the stacking conveyor, if supporting one or more previously deposited substrates with a food product, is moveable in a first direction in response to the fail output signal so as to provide an exposed surface for receiving a failed substrate and food product, and wherein the stacking conveyor is moveable in a second direction opposite the first direction so as to reposition the one or more previously deposited substrates with the food product under the at least one support.

6. The food product stacker of claim 1 wherein the imaging device comprises a camera.

7. A food processing system comprising the stacker of claim 5, and further comprising an interleaver positioned upstream of the stacker, wherein the interleaver deposits the food product onto the substrate.

8. The food processing system of claim 7 further comprising a reject conveyor positioned to receive the failed substrate and food product from the stacking conveyor as the stacking conveyor is moved in the second direction.

9. The food processing system of claim 8 wherein the stacker comprises a first stacker, and further comprising a diverter positioned between the interleaver and the first stacker, wherein the diverter is configured to feed the substrates supporting the food product alternatively to the first stacker and to a second stacker, wherein the second stacker comprises at least one second support moveable between a second support position and a second release position, a second machine vision system comprising a second imaging device having a field of view encompassing the second support platform and configured to capture an image of the substrate supporting the food product supported by the second support platform, and a second processor configured to process the image and determine a position of the substrate on the second support platform, wherein the second processor is configured to provide a second offset output signal corresponding to the position of the substrate on the second support platform, and a second stacking conveyor positioned under the second support and configured to receive the substrate supporting the food product when the second support is moved to the release position, wherein the second stacking conveyor is moveable in response to the second offset output signal.

10. A method of stacking substrates with food product comprising:
moving a substrate supporting a food product onto a support defining a support platform;
capturing an image of the substrate supporting the food product on the support platform with an imaging device;
processing the image of the substrate supporting the food product with a processor;
determining a position of the substrate supporting the food product on the support platform;
generating an offset output signal corresponding to the position of the substrate on the support platform;
moving a stacking conveyor in response to the offset output signal;
moving the support so as to release the substrate supporting the food product; and
depositing the substrate supporting the food product onto the stacking conveyor.

11. The method of claim 10 wherein moving the substrate supporting the food product onto the support comprises moving the substrate supporting the food product onto a pair of stacker paddles rotatably mounted about laterally spaced rotation axes, and wherein moving the support so as to release the substrate supporting the food product comprises rotating the pair of stacker paddles about the rotation axes between a support position and a release position, wherein the support paddles define an opening therebetween when rotated to the release position.

12. The method of claim 11 wherein the stacker paddles have a horizontal orientation in the support position and a vertical orientation in the release position.

13. The method of claim 10 wherein moving the substrate supporting the food product onto the support comprises feeding the substrate supporting the food product to the support from an infeed conveyor positioned upstream of the support.

14. The method of claim 10 further comprising determining whether the substrate and/or the food product on the support platform satisfies one or more pass/fail criteria and generating a pass output signal or a fail output signal.

15. The method of claim 14 moving the stacking conveyor, if supporting one or more previously deposited substrates with a food product, in a first direction in response to the fail output signal so as to provide an exposed surface for receiving a failed substrate and food product, releasing the failed substrate and food product onto the exposed surface, and moving the stacking conveyor in a second direction opposite the first direction so as to reposition the one or more previously deposited substrates with the food product under the support.

16. The method of claim 15 further comprising receiving the failed substrate and food product with a reject conveyor as the staking conveyor is moved in the second direction.

17. The method of claim 10 wherein the imaging device comprises a camera.

18. The method of claim 10 further comprising interleaving the substrate under the food product with an interleaver upstream of the support.

19. The method of claim 10 wherein the support comprises a first support defining a first support platform, and further comprising diverting at least one of the substrates supporting the food product and moving one of the diverted substrates supporting the food product onto a second support defining a second support platform;
capturing a second image of the diverted substrate supporting the food product on the second support platform with a second imaging device;
processing the image of the diverted substrate supporting the food product with a second processor;
determining a position of the diverted substrate supporting the food product on the second support platform;
generating a second offset output signal corresponding to the position of the diverted substrate on the second support platform;
moving a second stacking conveyor in response to the second offset output signal;
moving the second support so as to release the diverted substrate supporting the food product; and
depositing the diverted substrate supporting the food product onto the second stacking conveyor.

20. The method of claim 10 wherein depositing the substrate supporting the food product onto the stacking conveyor further comprises successively stacking a plurality of the substrates supporting the food product one on top of another on the stacking conveyor.
